(19) United States
(12) Patent Application Publication
(10) Pub. No.: US 2020/0274777 A1
(43) Pub. Date: Aug. 27, 2020

(54) METHOD AND SYSTEM FOR PRIORITY-BASED DYNAMIC PROVISIONING OF APPLICATION SERVICES

(71) Applicant: Verizon Patent and Licensing Inc., Arlington, VA (US)

(72) Inventors: Weimin Liu, Chatham, NJ (US); Yuk Lun Li, Morganville, NJ (US); Indraneel Sen, Livingston, NJ (US); Serhad Doken, Bryn Mawr, PA (US)

(21) Appl. No.: 16/287,425

(22) Filed: Feb. 27, 2019

(51) Int. Cl. H04L 12/24; H04L 29/06; H04W 4/50; H04L 12/26

(52) U.S. Cl. CPC H04L 41/5041; H04L 65/4084; H04L 65/607; H04L 43/0876; H04L 41/0806; H04L 41/0813; H04W 4/50

(57) ABSTRACT

A method, a device, and a non-transitory storage medium are described in which a priority-based dynamic provisioning service is provided. A network device of an application service network may dynamically provision a function of the application service based on current resource utilization and one or multiple criteria. A spatial resolution or a progressive encoding of content delivered to users may dynamically change based on the dynamic provisioning of the function of the application service.

### BACKGROUND

Development and design of networks present certain challenges from a network-side perspective and an end device perspective. In order to enhance performance, multi-access edge computing (MEC) (also known as mobile edge computing (MEC)) is being explored in which core network capabilities (e.g., computational, storage, communication links, etc.) are situated at the network edge in order to reduce traffic being sent to the core network.

### BRIEF DESCRIPTION OF THE DRAWINGS

FIG. 1 is a diagram illustrating an exemplary environment in which an exemplary embodiment of a priority-based dynamic provisioning service may be implemented;

FIG. 2A is a diagram illustrating exemplary information that may be used in support of the priority-based dynamic provisioning service;

FIG. 2B is a diagram illustrating exemplary state information that may be used in support of the priority-based dynamic provisioning service;

FIGS. 3A-3E are diagrams illustrating an exemplary process of an exemplary embodiment of the priority-based dynamic provisioning service;

FIG. 4 is a diagram illustrating exemplary information of the priority-based dynamic provisioning service according to an exemplary scenario;

FIG. 5 is a diagram illustrating exemplary components of a device that may correspond to one or more of the devices illustrated and described herein; and

FIG. 6 is a flow diagram illustrating an exemplary process of an exemplary embodiment of the priority-based dynamic provisioning service.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

A wireless network should support various use cases, meet various performance metrics, allow for scalability and flexibility, and so forth. In the design of the wireless network, a MEC network is being considered. The integration of the MEC network may reduce the traffic sent to and received from the core network. Additionally, the MEC network may provide various services and applications to end devices with minimal latency.

MEC networks or other types of networks may not always have sufficient available resources to accommodate all end devices at all times. For example, the MEC network may have insufficient resources (e.g., physical, logical, virtual) due to the number of end devices/users being served, the number of applications running simultaneously, the amount of content data involved in relation to the applications (e.g., 3D extreme reality, etc.), the state of the MEC network or other type of network (e.g., network in the process of being deployed, reconfigured, upgraded, etc.), and/or the state of neighboring MEC networks or other networks (e.g., failures, congestion, etc.). As a result, the MEC network or other types of networks may be unable to support a level of quality of service associated with an application. For example, the delivery of an application service to an end device may suffer from degradation of various performance metrics, such as latency, error rate, throughput, etc. Additionally, some users of an application service may be denied service, and other users may experience intermittent application service.

According to exemplary embodiments, a priority-based dynamic provisioning service is described. According to an exemplary embodiment, the priority-based dynamic provisioning service may be implemented by a MEC network. According to other exemplary embodiments, the priority-based dynamic provisioning service may be implemented by another type of application or service layer network. For example, the network may include the Internet, the World Wide Web (WWW), an Internet Protocol Multimedia Subsystem (IMS) network, a Rich Communication Service (RCS) network, a cloud network, a packet-switched network, a data center, a private network, or other type of network that hosts an end device application or service, or another type of end device asset.

According to an exemplary embodiment, the priority-based dynamic provisioning service manages the processing of an application and/or service (e.g., also referred to as “application service”) by a network device. For example, depending on the application service, the processing of the application service may include one or multiple functions, such as analyzing content, rendering content, delivering content, calculating a value, or another type of function that is performed to provide the application service to an end device or another type of device. According to an exemplary embodiment, the processing of content includes progressive content processing. For example, the progressive content processing may include spatial resolution of content, progressive encoding of content, interlaced encoding of content, or other techniques that may prioritize and deliver content based on a level of its importance.

According to an exemplary embodiment, the priority-based dynamic provisioning service includes monitoring the usage of resources used to provide the application service. According to various exemplary implementation, the resources may include physical resources, virtual resources, and/or logical resources of a network device, as described herein. According to an exemplary embodiment, the priority-based dynamic provisioning service may calculate a resource usage value (e.g., used resources/available, a percentage (e.g., 50%, etc.), etc.) pertaining to the resource based on the monitoring.

According to an exemplary embodiment, the priority-based dynamic provisioning service includes dynamically processing the application service based on a current resource usage and one or multiple criteria. According to various exemplary embodiments, the one or multiple criteria include a priority associated with the application service relative to other application services, a priority or an importance associated with content and/or information of the application service relative to other content and/or information of the application service, a subscription level or service tier of a user or the end device to which the application service is being provided, and/or a performance metric indicator (e.g., Quality of Experience (QoE) Score, a Mean Opinion Score (MOS) associated with users and/or application services, a Key Performance Indicator (KPI)).

According to an exemplary embodiment, resource usage values may be correlated to different values of the one or multiple criteria. For example, a resource usage value or a range of resource usage values may be mapped to processing the application service according to a value of a performance metric indicator and/or a priority or importance assigned to content and/or information of the application service, while a different resource usage value or different range of resource usage values may mapped to processing the application service according to a different value of the performance metric indicator and/or a priority or importance assigned to different content and/or information of the application service.

In view of the foregoing, the priority-based dynamic provisioning service may prevent or minimize congestion, failures, total denial of service, or overload, preserve the life of application service sessions with end devices, preserve a preferred balance of service levels to different users, and potentially service new requests from end devices for application services while still maintaining current application service sessions.

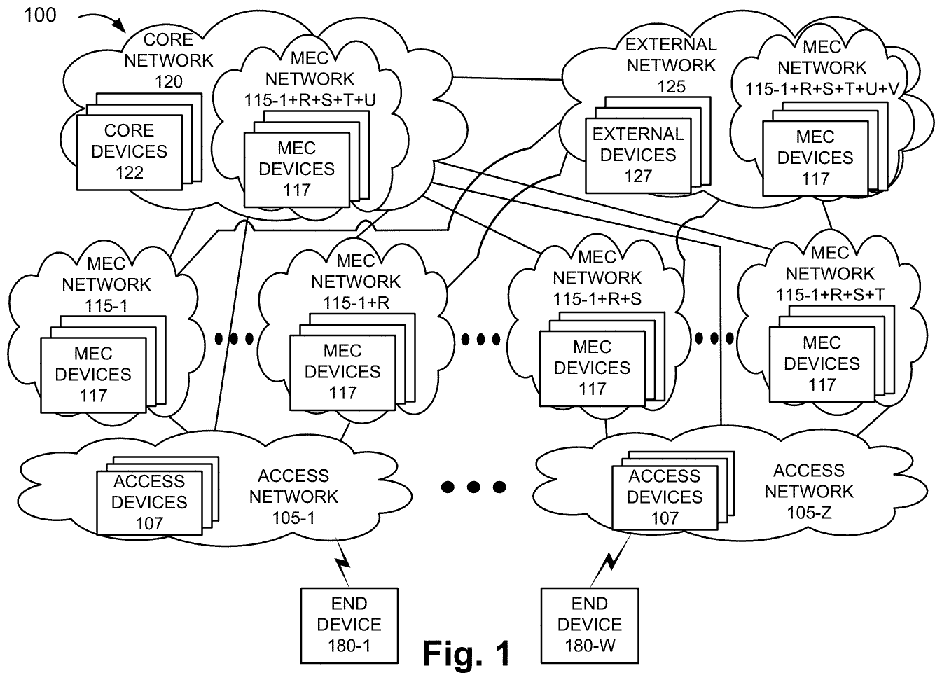

FIG. 1 is a diagram illustrating an exemplary environment 100 in which an exemplary embodiment of the priority-based dynamic provisioning service may be implemented. As illustrated, environment 100 includes access networks 105-1 through 105-Z (referred to collectively as access networks 105, and individually or generally as access network 105), MEC network 115-1 through 115-1+R+S+T+U+V (referred collectively as MEC networks 115, and individually or generally as MEC network 115), a core network 120, and an external network 125. Access network 105 includes access devices 107. MEC network 115 includes MEC devices 117. Core network 120 includes core devices 122. External network 125 includes external devices 127. Environment 100 further includes end devices 180-1 through 180-W (referred to collectively as end devices 180, and individually or generally as end device 180).

The number, the type, and the arrangement of network devices, and the number of end devices 180 are exemplary. A network device, a network element, or a network function (referred to herein simply as a network device) may be implemented according to one or multiple network architectures, such as a client device, a server device, a peer device, a proxy device, a cloud device, a virtualized function, and/or another type of network architecture (e.g., Software Defined Networking (SDN), virtual, logical, network slicing, etc.). Additionally, a network device may be implemented according to various computing architectures, such as centralized, distributed, cloud (e.g., elastic, public, private, etc.), edge, fog, and/or another type of computing architecture.

According to other exemplary embodiments, environment 100 may include additional networks, fewer networks, and/or different networks than those illustrated and described herein. For example, environment 100 may not include external network 125. Additionally, or alternatively, environment 100 may include a fog network, a backhaul network, a fronthaul network, and/or another type of network not specifically mentioned herein. Additionally, or alternatively, although MEC network 115 is described as providing the priority-based dynamic provisioning service, according to other exemplary embodiments, other types of application service layer networks (e.g., the Internet, an IMS network, a public network, a fog network, an RCS network, etc.) may be implemented to include the priority-based dynamic provisioning service, as described herein.

Environment 100 includes communication links between the networks, between the network devices, and between end devices 180 and the network/network devices. Environment 100 may be implemented to include wired, optical, and/or wireless communication links among the network devices and the networks illustrated. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number and the arrangement of communication links illustrated in environment 100 are exemplary.

Environment 100 may include various planes of communication including, for example, a control plane, a user plane, and a network management plane. Environment 100 may include other types of planes of communication. A message communicated in support of the priority-based dynamic provisioning service may use at least one of these planes of communication. Additionally, an interface of a network device (e.g., an interface defined by a standards body, such as Third Generation Partnership Project (3GPP), International Telecommunication Union (ITU), European Telecommunications Standards Institute (ETSI), etc.) may be modified in order to support the communication (e.g., transmission and reception of messages, information elements (IE), attribute value pairs (AVPs), etc.) between network devices and the priority-based dynamic provisioning service, as described herein. According to various exemplary implementations, the interface may be a service-based interface or a reference point-based interface.

Access network 105 may include one or multiple networks of one or multiple types and technologies. For example, access network 105 may be implemented to include a Fourth Generation (4G) radio access network (RAN) (e.g., an Evolved UMTS Terrestrial Radio Access Network (E-UTRAN) of a Long Term Evolution (LTE) network), a 4.5G RAN (e.g., an E-UTRAN of an LTE-Advanced (LTE-A) network), an RAN of an LTE-A Pro network, a next generation RAN (e.g., a Fifth Generation (5G)-access network (5G-AN) or a 5G-RAN (referred to herein as simply a 5G-RAN)), and/or another type of future generation RAN. Access network 105 may include other types of RANs (e.g., a Third Generation (3G) RAN, a 3.5G RAN, a U-TRAN, a Universal Mobile Telecommunications System (UMTS) RAN, a Global System for Mobile Communications (GSM) RAN, a GSM EDGE RAN (GERAN), a Code Division Multiple Access (CDMA) RAN, a Wideband CDMA (WCDMA) RAN, an Ultra Mobile Broadband (UMB) RAN, a High-Speed Packet Access (HSPA) RAN, and/or an Evolution Data Optimized (EV-DO) RAN).

Access network 105 may communicate with other types of access networks, such as, for example, a WiFi network, a Worldwide Interoperability for Microwave Access (WiMAX) network, a local area network (LAN), a Citizens Broadband Radio System (CBRS) network, a cloud RAN, a wired network (e.g., optical, cable, coaxial, copper, etc.), or another type of network that provides access to or can be used as an on-ramp to access network 105, MEC network 115, and/or core network 120.

Access network 105 may include different and multiple functional splitting, such as options 1, 2, 3, 4, 5, 6, 7, or 8 that relate to the splitting of the physical layer, Media Access Control (MAC), Radio Link Control (RLC), and Packet Data Convergence Control (PDCP), plane splitting (e.g., user plane, control plane, etc.), centralized unit (CU) and distributed unit (DU), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA), network slicing, coordinated multipoint (CoMP), and/or another type of connectivity service.

According to various exemplary embodiments, access network 105 may be implemented to include various architectures of wireless service, such as, for example, macrocell, microcell, femtocell, picocell, metrocell, new radio (NR) cell, LTE cell, non-cell, or another type of cell architecture. Additionally, according to various exemplary embodiments, access network 105 may be implemented according to various wireless technologies (e.g., radio access technology (RAT), etc.), wireless standards, wireless frequencies/bands, and different segments of radio spectrum (e.g., centimeter (cm) wave, millimeter (mm) wave, below 6 Gigahertz (GHz), above 6 GHz, licensed radio spectrum, unlicensed radio spectrum, carrier frequency, etc.).

Depending on the implementation, access network 105 may include one or multiple types of network devices that are illustrated in FIG. 1 as access devices 107. For example, access devices 107 may be implemented to include an evolved Node B (eNB), an eLTE eNB, a next generation Node B (gNB), a base station (BS), a base transceiver station (BTS), a Node B, a remote radio head (RRH), an RRH and a baseband unit (BBU), a BBU, a radio network controller (RNC), a small cell node (e.g., a picocell device, a femtocell device, a microcell device, a home eNB, a repeater, etc.), or another type of network device that provides a wireless access service. According to an exemplary embodiment, access device 107 includes logic that provides a priority-based dynamic provisioning service, as described herein.

MEC network 115 includes a platform that provides an application service. As illustrated, MEC network 115 may be located at an edge of a network, such as access network 105, or co-located with various types of network, such as core network 120 or external network 125. MEC network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology.

Depending on the implementation, MEC network 115 may include various types of network devices that are illustrated in FIG. 1 as MEC devices 117. For example, MEC devices 117 may include virtualized network functions (VNFs), multi-access (MA) applications/services, and/or servers for use by end devices 180.

MEC devices 117 may provide various end device and user device applications or services (referred to as application services). For example, the application services may pertain to broadband services in dense areas (e.g., pervasive video, smart office, operator cloud services, video/photo sharing, etc.), broadband access everywhere (e.g., 50/100 Mbps, ultra low-cost network, etc.), higher user mobility (e.g., high speed train, remote computing, moving hot spots, etc.), Internet of Things (IoTs) (e.g., smart wearables, sensors, mobile video surveillance, smart cities, connected home, etc.), extreme real-time communications (e.g., tactile Internet, augmented reality, etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), and/or broadcast-like services.

According to an exemplary embodiment, MEC devices 117 of MEC network 115 may include logic that provides a priority-based dynamic provisioning service, as described herein. According to an exemplary embodiment, the priority-based dynamic provisioning service monitors usage of network resources (e.g., physical, logical, virtual) at MEC device 117, as described herein. For example, the physical resources may include a processor (e.g., a central processing unit (CPU), a graphic processing unit (GPU), a neural processing unit (NPU), etc.), a memory (e.g., a read only memory (ROM), a random access memory (RAM), a solid state memory, etc.), a storage device (e.g., a hard drive, a non-volatile storage component, etc.), and/or a communication interface (e.g., a transmitter, a receiver, a buffer, a port, etc.). The physical resources may further include other types of network resources that are external to (e.g., not at MEC device 117), such as communication links between MEC devices 117, between other networks, between MEC device 117 and end device 180, or other communication links that support the provisioning of the application service. The logical resources may be a partition of a physical resource dedicated to or allocated to MEC device 117 or shared between a set of MEC devices 117. The virtual resources may be an abstraction of physical and/or logical resources.

According to an exemplary embodiment, the priority-based dynamic provisioning service calculates a resource usage value in correspondence to the available network resources, as described herein. According to various exemplary implementations, the resource usage value may be calculated periodically, continuously, and/or in response to a configured trigger event (e.g., a threshold congestion value, the beginning and/or end of an application service session, a particular operation performed by the application service, etc.). The priority-based dynamic provisioning service may use various techniques, such as polling or using interrupts.

According to an exemplary embodiment, the priority-based dynamic provisioning service dynamically provides the application service based on the current resource usage value and one or multiple criteria, as described herein. For example, the one or multiple criteria may include a priority associated with the application service relative to other application services, a priority associated with content and/or information of the application service relative to other content and/or information of the application service, a subscription level or service tier of a user or end device 180 to which the application service is being provided, and/or a performance metric indicator (e.g., a QoE value, an MOS value, a KPI value, a quality of service (QoS) value, or another type of performance indicator value). According to other exemplary embodiments, the priority-based dynamic provisioning service may dynamically provide the application service based on other criteria, such as context information pertaining to the mobility of end device 180, a time period remaining for the application service session (e.g., content streaming of a movie, etc.), and/or other types of configurable parameters.

According to an exemplary embodiment, the priority-based dynamic provisioning service dynamically manages the spatial resolution of content and/or information of the application service. For example, when the current resource usage value is high and the correlated one or multiple criteria values are considered, a lower granularity of content and/or information of the application service may be provided to end device 180 relative to when the current resource usage value is medium, low, or another lower value and consideration of the correlated one or multiple criteria values. According to an exemplary implementation, the granularity of content and/or information may pertain to the resolution of the content and/or information (e.g., standard definition versus high definition or 4K). According to an exemplary implementation, the granularity of content and/or information may pertain to the progressive rendering of the content and/or information.

According to another exemplary embodiment, the priority-based dynamic provisioning service dynamically manages the granularity of the content and/or information based on an importance of various sub-sets of the content and/or information. According to various exemplary embodiments, the application service may define or the priority-based provisioning service may define (e.g., based on the type of application service) varying levels of importance for the content and/or information. For example, with reference to a virtual, augmented, or mixed reality application service, the walls and ceiling of a building, doors, and/or other people may be assigned the highest level of importance, while furniture within a room may be assigned a lower level of importance relative to the walls and ceiling, doors, and/or other people, and paintings, artwork, flowers, bushes, etc., may be assigned an even lower level of importance. In this regard, for example, within a virtual environment, various objects and things within a user's view may be ranked or assigned a level of importance or priority.

As described herein, based on some nomenclature of granularity (e.g., coarse through fine, high through low, etc.), content and/or information may be dynamically provided in correspondence to the current resource usage value and the correlated one or multiple criteria values. Depending on the one or multiple criteria values, a high current resource usage value, for example, may not necessarily yield a lower granularity of content and/or information because the priority associated with the application service (e.g., high criticality, etc.), the subscription level of end device 180, and/or other criterion value may prevent any reduction of granularity or may minimize the reduction of granularity of the content and/or information being provided relative to other application service sessions that may be associated with different criteria values. End devices 180 may render partially delivered content and/or information and progressively refine the rendering as subsequent, lower-priority content and/or information is received. According to various exemplary scenarios, progressive content delivery may include the progressive representation of content, such as progressive web page rendering, progressive imaging of a still picture, interlaced or progressive encoding of video, progressive 3D representations of extreme or virtual reality, rough location data with progressively finer location data, artificial intelligence group identification with finer identification pertaining to objects, people, etc., and other types of application services that include image-based content rendering or analytic functions.

According to an exemplary embodiment, the priority-based dynamic provisioning service may dynamically change the number of end devices 180 being served by an application service, dynamically re-allocate network resources pertaining to an application service and/or an application service session of end device 180, provide a differentiated application service among end devices 180 of the same application service based on the one or multiple criteria values (e.g., based on differences in subscription levels, etc.), and/or provide a differentiated application service among end devices 180 of different application services based on the one or multiple criteria values (e.g., based on differences of a type or a category of application service, etc.). The priority-based dynamic provisioning service may restore lower priority or less important content and/or information that had been de-allocated during an application service session based on a change of the current resource usage value, etc., and degrade or recall lower priority or less important content and/or information that had been allocated during an application service session based on a change of the current resource usage value, etc.

According to an exemplary embodiment, the priority-based dynamic provisioning service may dynamically provide the application service based on historical information pertaining to correlations between network resource usage values and performance indicator values. For example, the priority-based dynamic provisioning service may manage the processing of the application service based on mappings between MOS values and MEC utilization ratio values for contents and/or information of each priority and/or level of importance.

According to an exemplary embodiment, MEC device 117 may include a database or another type of data repository or data structure that stores dynamic application service information in support of the priority-based dynamic provisioning service. According to another exemplary embodiment, although not illustrated, the information may be stored by another network device which MEC device 117 may access. MEC device 117 may include logic that uses the dynamic application service information to determine whether to modify the current provisioning or processing performed by the application service. An exemplary embodiment of dynamic application service information is described further below.

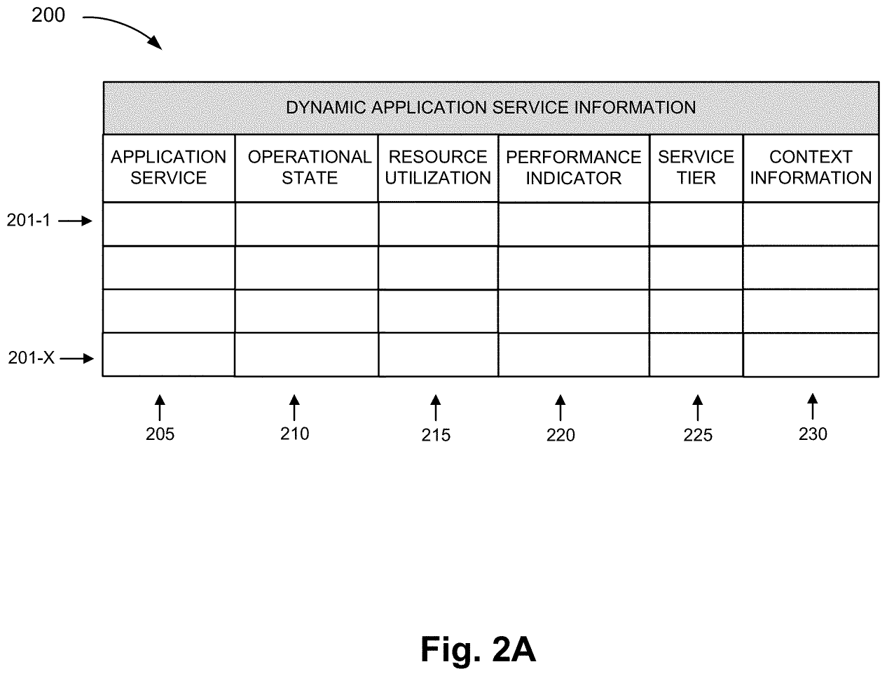

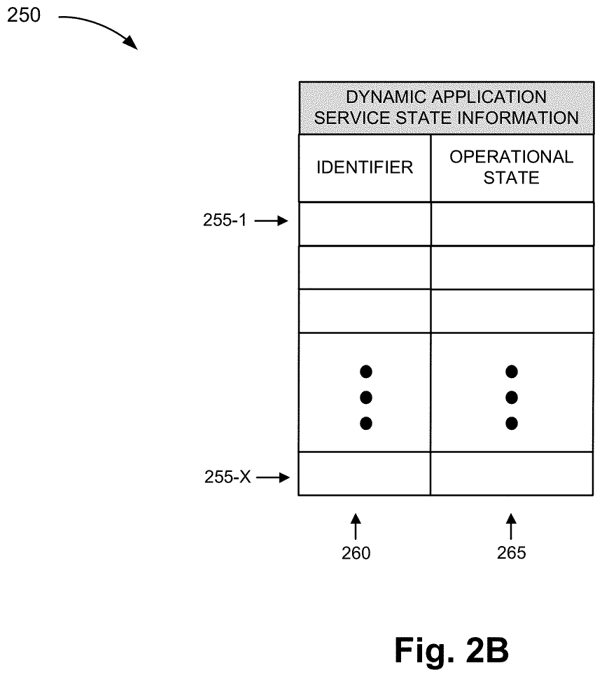

FIG. 2A is a diagram illustrating exemplary dynamic application service information that may be stored in a table 200. As illustrated, table 200 may include an application service field 205, an operational state field 210, a resource utilization field 215, a performance indicator field 220, a service tier field 225, and a context information field 230. As further illustrated, table 200 includes records 201-1 through 201-X (also referred to as records 201, or individually or generally as record 201) that each includes a grouping of fields 205, 210, 215, 220, 225, and 230. Dynamic application service information is illustrated in tabular form merely for the sake of description. In this regard, dynamic application service information may be implemented in a data structure different from a table.

Application service field 205 may store data indicating a particular application service and/or a category of an application service (e.g., extreme real-time, mission critical, video streaming, etc.).

Operational state field 210 may store data indicating an operational state of a function of the application service. For example, as previously described, different operational states of a delivery function of an application service may include varying degrees of the amount and/or type of content and/or information delivered. By way of further example, the application service may use different degrees of spatial resolution or progressive rendering as a basis to delivery content and/or information having varying levels of priority and/or importance. According to an exemplary implementation, the priority or the importance of the content and/or information may be assigned a value corresponding to particular gradation of the operational state of the delivery function.

According to other examples, depending on the application service, other types of functions of an application service may have different operational states, such as the number or type of values calculated, a degree of analysis of data, a precision for determining a geographic location of a person, place, or thing, and/or other sub-operations that may be performed by the application service. Operational state field 210 may store data that identifies the function. For example, operational state field 210 may store an identifier that identifies the content delivery function, and another identifier that identifies an analyzing function of the application service. Depending on the number of functions of the application service subject to the priority-based dynamic provisioning service, operational state field 210 may identify a particular function and a state or parameter associated with the operation of that function. Additionally, depending on the functions of the application service, there may be some functions subject to the priority-based dynamic provisioning service, while other functions may not. For example, an analyzing function or a content delivery function of a network device, which hosts an application service, may be subject to the priority-based dynamic provisioning service, while an ingestion function (e.g., to receive content) or another type of function of the application service may not be subject to the priority-based dynamic provisioning service.

Resource utilization field 215 may store data indicating a resource utilization value or range of resource utilization values pertaining to one or multiple network resources (e.g., physical, logical, virtual). The resource utilization value or the range of resource utilization values may be a threshold resource utilization value or a threshold range of resource utilization values to be used as a comparative for a current resource utilization value that is measured or calculated during an application service session or during the execution of the application service on a network device (e.g., MEC device 117, etc.).

Performance indicator field 220 may store data indicating one or multiple performance indicator values. The performance indicator may represent a level of performance associated with the application service in view of the correlated values in other fields of record 201. For example, a resource utilization value of 100 may yield a performance indicator value of 4.9 (e.g., a highest performance value for the application service), while a resource utilization value of 12 may yield a performance indicator value of 2.4 (e.g., a low performance value for the application service). By way of further example, with reference to the content delivery of the application service, the performance indicator value of 4.9 may correspond to when the application service delivers all content and/or information at its highest resolution or all levels of importance of the content and/or information. On the other hand, the performance indicator value of 2.4 may correspond to when the application service may not deliver content (e.g., all or some) at its highest resolution or only a portion of the content and/or information (e.g., based on the level of importance) may be delivered.

Service tier field 225 may store data indicating a level or tier of subscription or service level pertaining to a user of end device 180 or end device 180. For example, the data may include subscription information pertaining to a wireless access service associated with the user and/or end device 180. By way of further example, under a four tier system, a first tier may be associated with the highest level of service, and may be afforded to mission critical application services (e.g., first responders, etc.), and may require all or nearly all content and/or information be delivered. A second tier may be associated with the next highest level of service, and so forth. According to other exemplary implementations, a different number of tiers or levels, different associations with a category of application service, delivery of content or other function of the application service, may be configured. The level or tier of subscription or wireless service may include various parameters pertaining to quality of service and/or performance metrics (e.g., guaranteed bit rate, maximum/minimum bit rate, packet error loss, throughput, etc.).

Context information field 230 may store data indicating context information other than that stored in fields 205 through 225. For example, context information may indicate values pertaining to mobility of end device 180, possibility of upcoming handover, state of the application session (e.g., just begun, near the end, etc.), number of new and pending requests to establish an application session, and/or other configurable parameters and values that may be used to manage the provisioning/processing of the application service.

According to other exemplary implementations, table 200 may store additional, fewer, and/or different instances of dynamic application service information in support of the priority-based dynamic provisioning service, as described herein. Additionally, or alternatively, the number of records 201 is exemplary.

MEC device 117, another type of network device that provides the application service, or a controller device may use the dynamic application service information as a basis to analyze whether or not the provisioning or the processing performed by the application service should be modified. For example, MEC device 117 may monitor and calculate the current resource utilization value and use other criteria (e.g., indicated in one or more fields 210-230) to determine the configuration for the application service. MEC device 117 may also compare the calculated configuration with the current configuration. According to an exemplary embodiment, dynamic application service state information, which indicates the current configuration or state of operation of the application service, may be used for comparison. An exemplary embodiment of dynamic application service state information is described further below.

FIG. 2B is a diagram illustrating exemplary dynamic application service state information that may be stored in a table 250. As illustrated, table 250 may include an identifier field 260 and an operational state field 265. As further illustrated, table 250 includes records 255-1 through 255-X (also referred to as records 255, or individually or generally as record 255) that each includes a grouping of fields 260 and 265. Dynamic application service state information is illustrated in tabular form merely for the sake of description. In this regard, dynamic application service state information may be implemented in a data structure different from a table.

Identifier field 260 may store data that identifies a user, end device 180, and/or an application service session. According to other examples, identifier field 260 may store data that identifies a virtual machine, a container, or other entity that hosts the application service and/or subject to resource-sharing mechanism.

Operational state field 265 may store data that identifies a current operational state of an application service. For example, in the context of the delivery function, operational state field 265 may store data indicating a priority value or an importance value corresponding to a level of spatial resolution or progressive rendering. According to other examples, other types of values associated a functional state of the application service may be used, as described herein. For example, operational state field 265 may store an identifier of a function of the application service, etc., as previously described in relation to operational state field 210.

According to other exemplary implementations, table 250 may store additional, fewer, and/or different instances of dynamic application service state information in support of the priority-based dynamic provisioning service, as described herein. While tables 200 and 250 have been illustrated and described as separate data, according to other exemplary embodiments, tables 200 and 250 may be combined and/or other data structure arrangements may be implemented.

According to an exemplary embodiment, the priority-based dynamic provisioning service may compare the value of operational state field 210 with operational state field 265 to determine whether these values are the same or not. When it is determined that the values are the same, the configuration may not be modified. When it is determined that the values are different, the configuration may be modified according to the value of operational state field 210. Over time, the operational state of the function of the application service may dynamically change depending on the monitoring of the network resource utilization and other criteria, as described herein.

Referring back to FIG. 1, MEC devices 117 may include other types of network devices, such as a network function virtualization orchestrator (NFVO), a virtualized infrastructure manager (VIM), an operations support system (OSS), a local domain name server (DNS), a virtual network function manager (VNFM), and/or other types of network devices (e.g., routers, core devices 122, etc.), and network resources (e.g., storage devices, communication links, etc.). According to some exemplary embodiments, a control layer network device may include logic that provides the priority-based dynamic provisioning service. For example, the VIM may be configured to monitor network resource utilization and calculate a current network resource utilization of the network device (e.g., VNF, etc.) that hosts the application service. According to another example, the VNFM may be configured to determine whether an operational state of the application service is to change, and invoke the change. According to other exemplary embodiments, various functions of the priority-based dynamic provisioning service may be centralized (e.g., a portion or all of the priority-based dynamic provisioning service at the network device that hosts the application service (e.g., MEC server device 117 of MEC network 115, etc.) or at a control layer network device (e.g., VIM, VNFM of MEC network 115, etc.)) or distributed between network devices of a network.

Core network 120 may include one or multiple networks of one or multiple network types and technologies. Core network 120 may include a complementary network of access network 105. For example, core network 120 may be implemented to include an Evolved Packet Core (EPC) of an LTE, an LTE-A, an LTE-A Pro, a next generation core (NGC) network, and/or a legacy core network.

Depending on the implementation of core network 120, core network 120 may include various types of network devices that are illustrated in FIG. 1 as core devices 122. For example, core devices 122 may include a mobility management entity (MME), a packet gateway (PGW), a serving gateway (SGW), a home subscriber server (HSS), an authentication, authorization, and accounting (AAA) server, a policy charging and rules function (PCRF), a charging system (CS), a user plane function (UPF), an access and mobility management function (AMF), a session management function (SMF), a unified data management (UDM) device, an authentication server function (AUSF), a network slice selection function (NSSF), a network repository function (NRF), a policy control function (PCF), and so forth. According to other exemplary implementations, core network 120 may include additional, different, and/or fewer network devices than those described.

External network 125 may include one or multiple networks of one or multiple network types and technologies. For example, external network 125 may be implemented to include a service or an application-layer network, the Internet, the World Wide Web (WWW), an Internet Protocol Multimedia Subsystem (IMS) network, a Rich Communication Service (RCS) network, a cloud network, a packet-switched network, a data center, a private network, or other type of network that hosts an end device application or service, or another type of end device asset.

Depending on the implementation of external network 125, external network 125 may include various network devices depicted in FIG. 1 as network devices 127. For example, network devices 127 may provide various applications, services, or another type of end device asset, such as a server (e.g., web, application, cloud, etc.), mass storage device, data center devices, routers, and/or other types of network devices pertaining to various network-related functions.

End device 180 includes a device that has computational and wireless communication capabilities. End device 180 may be implemented as a mobile device, a portable device, a stationary device (e.g., a non-mobile device), a device operated by a user, or a device not operated by a user. For example, end device 180 may be implemented as a mobile broadband device, a smartphone, a computer, a tablet, a netbook, a phablet, a wearable device, a vehicle support system, a drone, or some other type of mobile wireless device. According to various exemplary embodiments, end device 180 may be configured to execute various types of software (e.g., applications, programs, etc.). The number and the types of software may vary among end devices 180. End device 180 may support one or multiple RATs (e.g., 4G, 5G, etc.), one or multiple frequency bands, network slicing, DC service, and so forth. Additionally, end device 180 may include one or multiple communication interfaces that provide one or multiple (e.g., simultaneous or non-simultaneous) connections via the same or different RATs, frequency bands, access devices 107, and so forth. According to an exemplary embodiment, end device 180 may include logic that provides a priority-based dynamic provisioning service, as described.

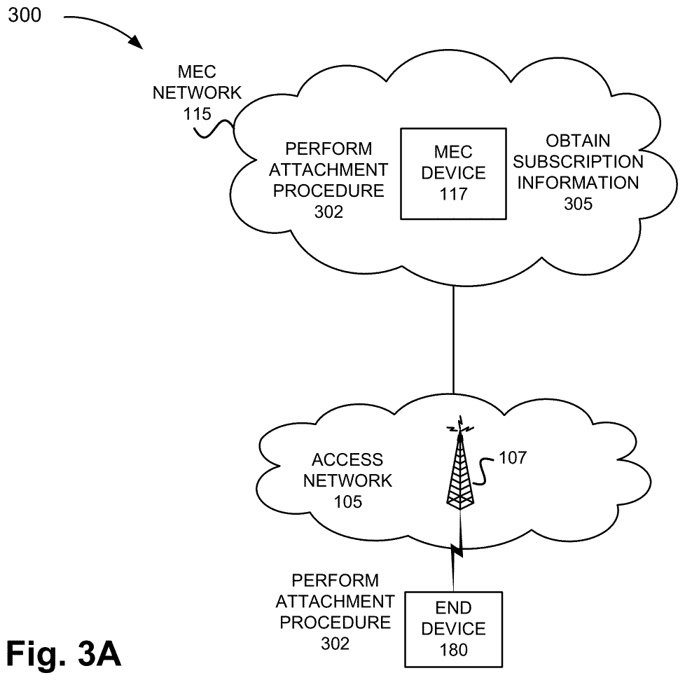

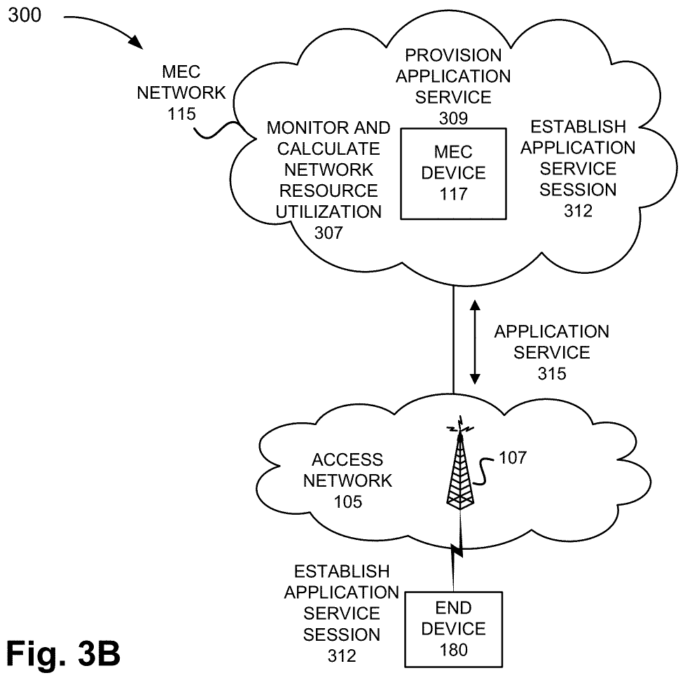

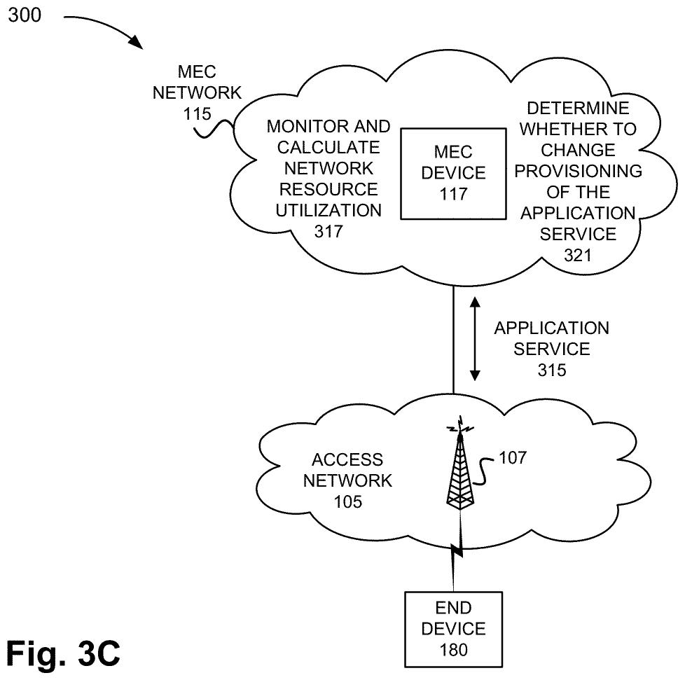

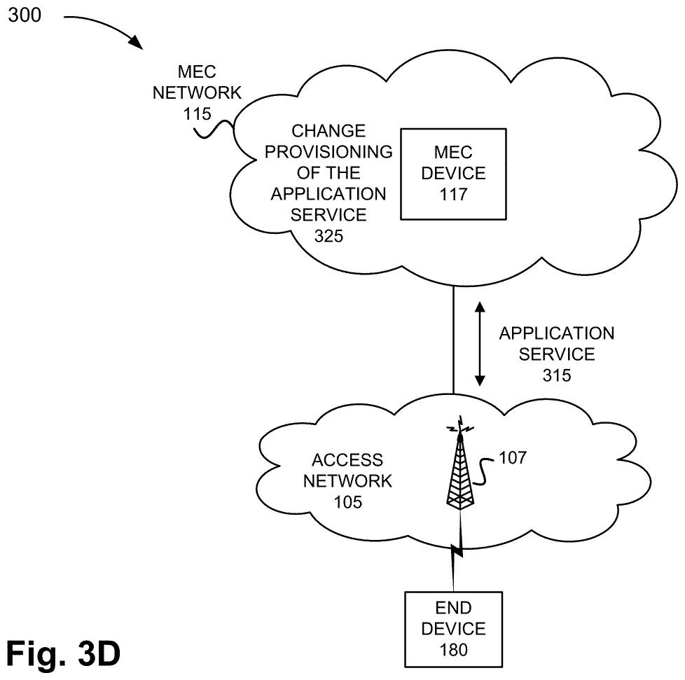

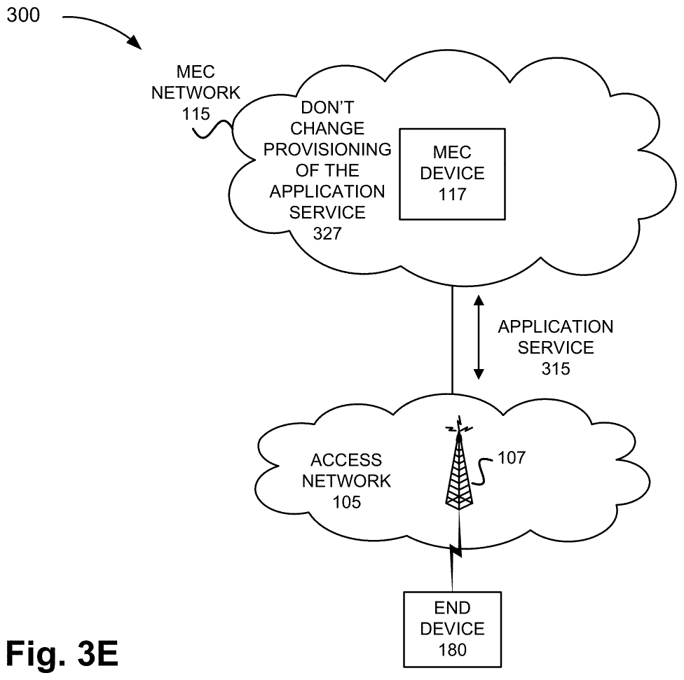

FIGS. 3A-3E are diagrams illustrating exemplary processes of the priority-based dynamic provisioning service in an exemplary environment 300 that is consistent with environment 100, as previously described. According to this exemplary embodiment, assume that MEC device 117 includes logic that provides the priority-based dynamic provisioning service. For example, MEC device 117 may be a MEC server device that hosts the application service. According to various exemplary implementations, MEC device 117 may or may not be a virtual device of a particular virtualization technology.

Referring to FIG. 3A, according to an exemplary scenario, assume that end device 180 and MEC device 117 perform an attachment procedure 302. According to an exemplary implementation, as a part of the attachment procedure, MEC device 117 may obtain subscription information 305 pertaining to end device 180. For example, MEC device 117 may obtain the subscription information from a network device (e.g., an HSS, a UDM, etc.) of core network 120, or from a network device of MEC network 115 that stores subscription information. The subscription information may store a level of service for end device 180 (and/or user associated with end device 180) and/or a tier of subscription.

Referring to FIG. 3B, MEC device 117 may monitor and calculate current network resource utilization 307. For example, MEC device 117 may monitor and determine network resource utilizations pertaining to physical, logical, and/or virtual network resources. Based on this information, MEC device 117 may provision an application service 309 for end device 180. For example, MEC device 117 may use the dynamic application service information to select an application service configuration. By way of further example, the type of application service requested, the current amount of network resources available, the tier of service pertaining to end device 180 or a user (not illustrated), and other context information may be used to select the operational state of the application service. MEC device 117 may configure the application service according to the selected application service configuration, and establish an application service session 312 with end device 180. MEC device 117 may store the selected application service configuration information (e.g., in table 250).

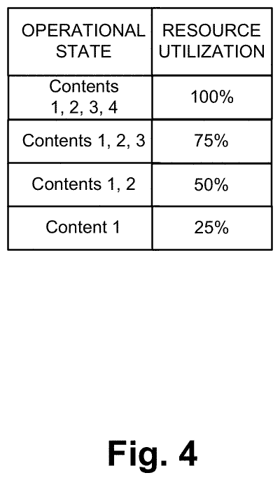

According to an exemplary scenario, referring to FIG. 4, assume that the application service may progressively render contents according to a priority scheme and various operational configurations of a content delivery function. According to an exemplary implementation, the application service may categorize contents in which each category of content may be assigned a priority value or an importance value. By way of example, there may be four (or a different number of) priority hierarchies, in which the highest priority of content may be content 1, the next highest priority of contents may be contents 1 and 2, and so forth. The operational state that deliveries only content 1 may be correlated to a lowest network resource utilization ratio (e.g., 25%) and a lowest performance indicator value (not illustrated). Conversely, the operational state that deliveries all of the content of the application service (e.g., contents 1, 2, 3, and 4, may be correlated to a highest network resource utilization value (e.g., 100%) and a highest performance indicator value (not illustrated). According to other exemplary implementations, the number of priorities, the number of contents, etc., may be different. The values illustrated and described are merely exemplary. Additionally, for example, depending on other criteria (e.g., level of service, tier of subscription, etc.), different end devices 180 may be afforded different provisioning of the application service and correspondingly different contents (e.g., only content 1 versus contents 1, 2, and 3, etc.). According to an exemplary embodiment, the priority-based dynamic provisioning service may regulate the delivery of content on a per end device 180 basis and/or on a per application service session basis.

Referring to FIG. 3C, subsequent to the establishment of the application session, MEC device 117 may monitor and calculate the current available network resource utilization 317. For example, MEC device 117 may again monitor and determine network resource utilizations pertaining to physical, logical, and/or virtual network resources. Based on this information, MEC device 117 may determine whether to change the provisioning of the application service 321. For example, MEC device 117 may compare the current operational state value of the application service (e.g., associated with table 200) to the previously configured operational state of the application service when the application service session was established (e.g., associated with table 200). Depending on the result of the comparison, MEC device 117 may or may not change the provisioning of the application service. For example, when the operational state values do not match, referring to FIG. 3D, MEC device 117 may change the provisioning of the application service 325. For example, the operational state of the delivery content function, as previously described, may increase (e.g., change from delivering contents 1 and 2 to delivering contents 1, 2, and 3 or contents 1, 2, 3, and 4, etc.) or decrease the contents (e.g., change from delivering contents 1, 2, 3, and 4 to delivering contents 1, 2, and 3, etc.) provided to end device 180. Alternatively, for example, when the operational state values match, referring to FIG. 3E, MEC device 117 may not change the provisioning of the application service 327. For example, the operational state of the delivery content function may remain constant. This process may continue and reiterate during the life of the application service session.

FIGS. 3A-3E illustrate an exemplary process of the priority-based dynamic provisioning service, according to other exemplary embodiments, the process may include additional, different, and/or fewer steps. For example, the priority-based dynamic provisioning service may continually obtain various types of context information, as described herein, which may be stored and used to determine the operational state for the application service. For example, the number of current users of the application service, mobility information pertaining to end devices 180 (e.g., handovers, etc.), and/or other types of context information.

According to various exemplary embodiments, the network resources available to a network device (e.g., a virtual device, a container, a virtual machine, a non-virtual device, etc.) that hosts the application service may be static or dynamic, include or not include reserves, include or not include an allocation bound limit (e.g., upper, lower, etc.), may be applied on a per device basis, a per virtual device basis, and/or other types of network resource configurations. According to some exemplary embodiments, network resource allocation or threshold values may serve as a trigger or basis for the priority-based dynamic provisioning service to modify the provisioning of the application service, as described herein. For example, in the context of content delivery, when a network resource allocation boundary value associated with one or multiple network resources is exceeded, the priority-based dynamic provisioning service may modify the content priorities delivered to one or multiple end devices 180. For example, with reference to progressive rendering, when end device 180 may be receiving contents 1, 2, 3, and 4, the priority-based dynamic provisioning service may decrease the amount of content to only contents 1, 2, and 3. Conversely, when network resource utilization falls below a network resource allocation boundary value, the priority-based dynamic provisioning service may modify the content priorities delivered to one or multiple end devices 180. For example, the priority-based dynamic provisioning service may increase the amount of content delivered. According to other examples, the priority-based dynamic provisioning service may not modify the content delivered to end device 180 based on other factors, such as the type of application service, the tier of subscription, etc., as previously described. Additionally, various schemes may be used for progressive content encoding (e.g., linear, non-linear, etc.) that may be mapped to various hierarchies, priorities, etc.

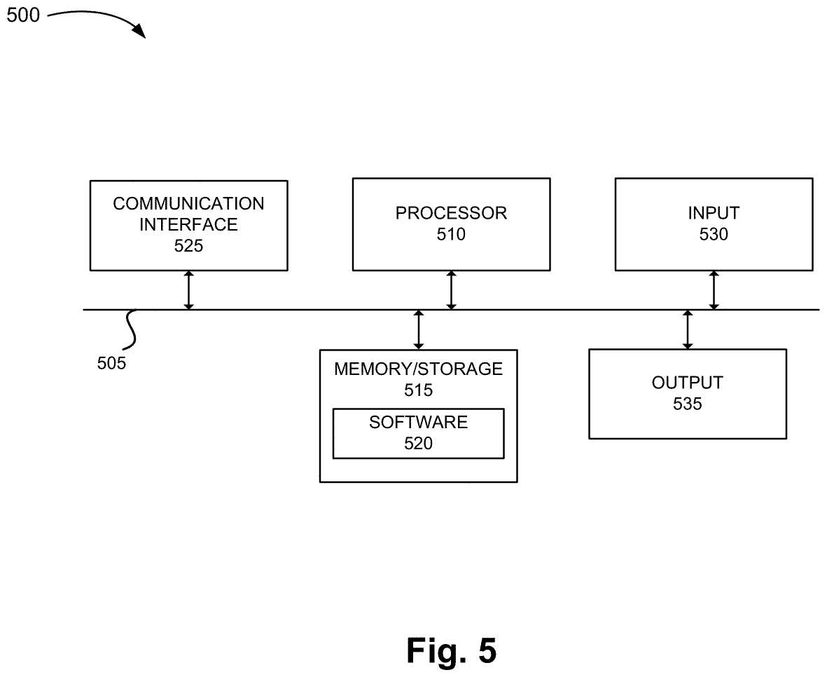

FIG. 5 is a diagram illustrating exemplary components of a device 500 that may be included in one or more of the devices described herein. For example, device 500 may correspond to components included in MEC device 117 of MEC network 115 or other types of network devices of other types of application service layer networks, as described herein. As illustrated in FIG. 5, device 500 includes a bus 505, a processor 510, a memory/storage 515 that stores software 520, a communication interface 525, an input 530, and an output 535. According to other embodiments, device 500 may include fewer components, additional components, different components, and/or a different arrangement of components than those illustrated in FIG. 5 and described herein.

Bus 505 includes a path that permits communication among the components of device 500. For example, bus 505 may include a system bus, an address bus, a data bus, and/or a control bus. Bus 505 may also include bus drivers, bus arbiters, bus interfaces, clocks, and so forth.

Processor 510 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 510 may be implemented as hardware (e.g., a microprocessor, etc.), a combination of hardware and software (e.g., a SoC, an ASIC, etc.), may include one or multiple memories (e.g., cache, etc.), etc.

Processor 510 may control the overall operation or a portion of operation(s) performed by device 500. Processor 510 may perform one or multiple operations based on an operating system and/or various applications or computer programs (e.g., software 520). Processor 510 may access instructions from memory/storage 515, from other components of device 500, and/or from a source external to device 500 (e.g., a network, another device, etc.). Processor 510 may perform an operation and/or a process based on various techniques including, for example, multithreading, parallel processing, pipelining, interleaving, etc.

Memory/storage 515 includes one or multiple memories and/or one or multiple other types of storage mediums. For example, memory/storage 515 may include one or multiple types of memories, such as, a random access memory (RAM), a dynamic random access memory (DRAM), a static random access memory (SRAM), a cache, a read only memory (ROM), a programmable read only memory (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 515 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 515 may include drives for reading from and writing to the storage medium.

Memory/storage 515 may be external to and/or removable from device 500, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray disk (BD), etc.). Memory/storage 515 may store data, software, and/or instructions related to the operation of device 500.

Software 520 includes an application or a program that provides a function and/or a process. As an example, with reference to MEC device 117, software 520 may include an application that, when executed by processor 510, provides a function of the priority-based dynamic provisioning service, as described herein. Software 520 may also include firmware, middleware, microcode, hardware description language (HDL), and/or other form of instruction. Software 520 may also be virtualized. Software 520 may further include an operating system (OS) (e.g., Windows, Linux, Android, proprietary, etc.).

Communication interface 525 permits device 500 to communicate with other devices, networks, systems, and/or the like. Communication interface 525 includes one or multiple wireless interfaces and/or wired interfaces. For example, communication interface 525 may include one or multiple transmitters and receivers, or transceivers. Communication interface 525 may operate according to a protocol stack and a communication standard. Communication interface 525 may include an antenna. Communication interface 525 may include various processing logic or circuitry (e.g., multiplexing/de-multiplexing, filtering, amplifying, converting, error correction, application programming interface (API), etc.). Communication interface 525 may be implemented as a point-to-point interface, a service based interface, etc.

Input 530 permits an input into device 500. For example, input 530 may include a keyboard, a mouse, a display, a touchscreen, a touchless screen, a button, a switch, an input port, speech recognition logic, and/or some other type of visual, auditory, tactile, etc., input component. Output 535 permits an output from device 500. For example, output 535 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, etc.). Device 500 may be implemented in the same manner. For example, device 500 may be instantiated, spun up, spun down, etc., using well-known virtualization techniques in a public/private cloud or other type of network.

Device 500 may perform a process and/or a function, as described herein, in response to processor 510 executing software 520 stored by memory/storage 515. By way of example, instructions may be read into memory/storage 515 from another memory/storage 515 (not shown) or read from another device (not shown) via communication interface 525. The instructions stored by memory/storage 515 cause processor 510 to perform a process described herein. Alternatively, for example, according to other implementations, device 500 performs a process described herein based on the execution of hardware (processor 510, etc.).

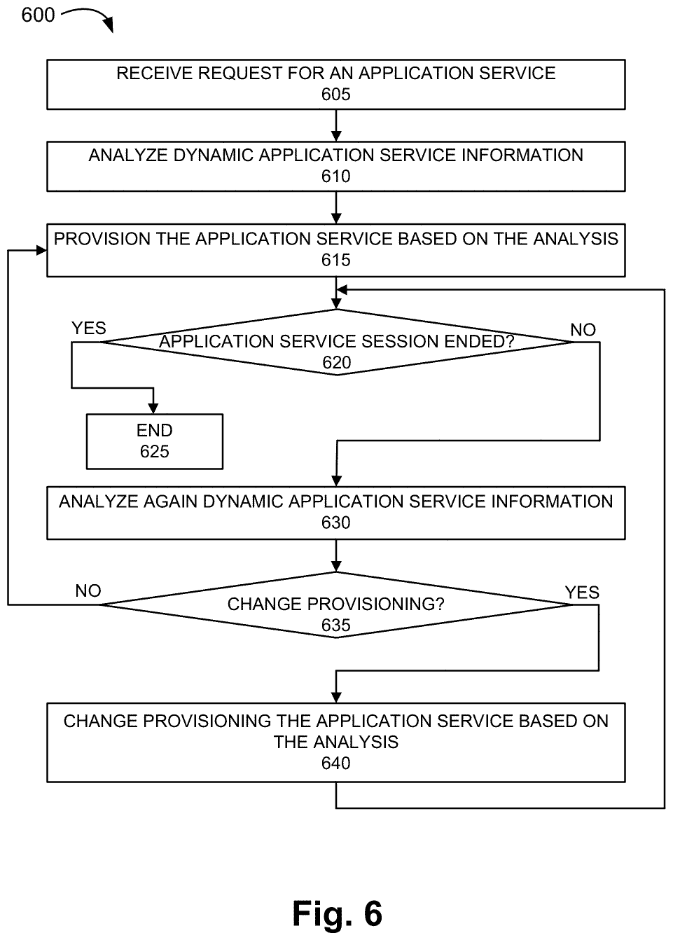

FIG. 6 is a flow diagram illustrating an exemplary process 600 of an exemplary embodiment of the priority-based dynamic provisioning service. According to an exemplary embodiment, MEC device 117 (e.g., a MEC server that hosts an application service) or another type of MEC device (e.g., a VIM or another type of control layer function) may perform, in whole or in part, steps of process 600. According to other exemplary embodiments, other types of network devices/networks may perform, in whole or in part, the steps of process 600, as described herein. According to an exemplary implementation, processor 510 executes software 520 to perform a step illustrated in FIG. 6, and described herein. Alternatively, a step illustrated in FIG. 6, and described herein, may be performed by execution of only hardware.

Referring to FIG. 6, in block 605, for example, a request for an application service may be received. For example, a network device, which includes logic that provides the priority-based dynamic provisioning service, may receive a request for the application service from end device 180.

In block 610, dynamic application service information may be analyzed. For example, the network device may analyze network resource utilization and one or multiple other criteria, as previously described. In block 615, the application service may be provisioned based on the analysis. For example, the network device may provision the application service based on the analysis of the network resource utilization and the one or multiple criteria. The network device may configure an operational state of one or multiple functions among multiple functions of the application service, as previously described. By way of further example, the function may pertain to content delivery (e.g., progressive content or spatial resolution) associated with a given content priority or importance of information. The network device may store dynamic application service state information, as previously described.

In block 620, it may be determined whether the application service session has ended. For example, subsequent to the provisioning, the network device may determine whether the application service session has ended before re-evaluating the provisioning of the application service.

When it is determined that the application service session has ended (block 620-YES), process 600 may end. For example, the network device may end the priority-based dynamic provisioning service for this application service session.

When it is determined that the application service session has not ended (block 620-NO), the dynamic application service information may be analyzed again (block 630). For example, the network device may again analyze network resource utilization and one or multiple other criteria, as previously described.

In block 635, it may be determined whether to change the provisioning of the application service. For example, the network device may compare an operational state value of the dynamic application service information with the operational state value of the dynamic application service state information, as previously described.

When it is determined that the provisioning of the application service is not to be changed (block 635-NO), process 600 may return to block 615. When it is determined that the provisioning of the application service is to be changed (block 635-YES), the provisioning of the application service may be changed based on the analysis (block 640). Process 600 may return to block 620.

FIG. 6 illustrates an exemplary process 600 of the priority-based dynamic provisioning service, however, according to other embodiments, process 600 may include additional operations, fewer operations, and/or different operations than those illustrated in FIG. 6, and described herein. For example, the network device may invoke the analyzing of the dynamic application service information based on the detection of various triggering events, as previously described.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration, but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks has been described with regard to the process illustrated in FIG. 6, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 510, etc.), or a combination of hardware and software (e.g., software 520).

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 510) of a device. A non-transitory storage medium includes one or more of the storage mediums described in relation to memory/storage 515. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, it should be understood that such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known to those of ordinary skill in the art are expressly incorporated herein by reference and are intended to be encompassed by the claims. No claim element of a claim is to be interpreted under 35 U.S.C. § 112(f) unless the claim element expressly includes the phrase “means for” or “step for.”

What is claimed is:

1. A method comprising:
receiving, by a network device and from an end device, a request for an application service;
analyzing, by the network device, network resource utilization of network resources at the network device and one or multiple other criteria;
selecting, by the network device based on the analyzing, a first operational state of multiple operational states of a content delivery function of the application service based on a network resource utilization value and one or multiple criteria values that correlate to the first operational state;
provisioning, by the network device based on the selecting, the content delivery function of the application service to operate in the first operational state to deliver a content; and
providing, by the network device, the application service to the end device using the content delivery function operating in the first operational state which includes delivering one of a first spatial resolution of multiple spatial resolutions of the content or delivering a first progressive encoding of multiple progressive encodings of the content.

2. The method of claim 1, wherein the network device includes a virtual device, and the network resource utilization includes at least one of processor utilization or memory utilization.

3. The method of claim 1, wherein the one or multiple criteria includes a category of an application pertaining to the application service.

4. The method of claim 1, wherein the application service defines multiple and different levels of importance for subsets of the content, and the delivering of the first progressive encoding of the content correlates to one of the multiple and different levels of importance and the network resource utilization value.

5. The method of claim 1, wherein the one or multiple criteria include one or multiple performance metric indicator values.

6. The method of claim 1, further comprising:
storing, by the network device in response to the providing, state information indicating the first operational state and an identifier pertaining to an application service session with the end device;
analyzing again, by the network device subsequent to the storing and before termination of the application service session, the network resource utilization at the network device and the one or multiple criteria;
determining, by the network device based on the analyzing again, whether to change the first operational state to a second operational state of the multiple operational states of the content delivery function, wherein the first operational state is different than the second operational state; and
changing, by the network device based on the determining, the first operational state to the second operational state.

7. The method of claim 6, further comprising:
comparing, by the network device, the state information to an operational state value generated based on the analyzing again; and
determining, by the network device, whether the operational state value indicates a same operational state as the state information.

8. The method of claim 1, wherein the one or multiple criteria includes a tier of wireless service associated with the end device, and wherein the network resource utilization pertains to one or more of physical resources, virtual resources, or logical resources allocated to the network device for provisioning the application service.

9. A network device comprising:
a communication interface;
a memory, wherein the memory stores instructions; and
a processor, wherein the processor executes the instructions to:
receive, via the communication interface from an end device, a request for an application service;
analyze network resource utilization of network resources at the network device and one or multiple other criteria;
select, based on the analysis, a first operational state of multiple operational states of a content delivery function of the application service based on a network resource utilization value and one or multiple criteria values that correlate to the first operational state;
provision, based on the selection, the content delivery function of the application service to operate in the first operational state to deliver a content; and
provide the application service to the end device using the content delivery function operating in the first operational state that includes delivering one of a first spatial resolution of multiple spatial resolutions of the content or delivering a first progressive encoding of multiple progressive encodings of the content.

10. The network device of claim 9, wherein the network device includes a virtual device, and the network resource utilization includes at least one of processor utilization or memory utilization.

11. The network device of claim 9, wherein the one or multiple criteria includes a category of an application pertaining to the application service.

12. The network device of claim 9, wherein the application service defines multiple and different levels of importance for subsets of the content, and the delivering of the first progressive encoding of the content correlates to one of the multiple and different levels of importance and the network resource utilization value.

13. The network device of claim 9, wherein the processor further executes the instructions to:
store, in response to the provision, state information indicating the first operational state and an identifier pertaining to an application service session with the end device;
analyze again, subsequent to the storage and before termination of the application service session, the network resource utilization and the one or multiple criteria;
determine, based on the analysis again, whether to change the first operational state to a second operational state of the multiple operational states of the content delivery function, wherein the first operational state is different than the second operational state; and
change, based on a determination to change the first operational state, the first operational state to the second operational state.

14. The network device of claim 13, wherein the processor further executes the instructions to:
compare the state information to an operational state value generated based on the analysis again; and
determine whether the operational state value indicates a same operational state as the state information.

15. The network device of claim 9, wherein the one or multiple criteria includes a tier of wireless service associated with the end device, and wherein the network resource utilization pertains to one or more of physical resources, virtual resources, or logical resources allocated to the network device for provisioning the application service.

16. The network device of claim 9, wherein the one or multiple criteria include one or multiple performance metric indicator values.

17. A non-transitory computer-readable storage medium storing instructions executable by a processor of a device, which when executed cause the device to:
receive, from an end device, a request for an application service;
analyze network resource utilization of network resources at the device and one or multiple other criteria;
select, based on the analysis, a first operational state of multiple operational states of a content delivery function of the application service based on a network resource utilization value and one or multiple criteria values that correlate to the first operational state;
provision, based on the selection, the content delivery function of the application service to operate in the first operational state to deliver a content; and
provide the application service to the end device using the content delivery function operating in the first operational state that includes delivering one of a first spatial resolution of multiple spatial resolutions of the content or delivering a first progressive encoding of multiple progressive encodings of the content.

18. The non-transitory computer-readable storage medium of claim 17, wherein the device includes a virtual device, and the network resource utilization includes at least one of processor utilization or memory utilization.

19. The non-transitory computer-readable storage medium of claim 17, wherein the one or multiple criteria include one or multiple performance metric indicator values.

20. The non-transitory computer-readable storage medium of claim 17, wherein the application service defines multiple and different levels of importance for subsets of the content, and the delivering of the first progressive encoding of the content correlates to one of the multiple and different levels of importance and the network resource utilization value.
